(19) United States
(12) Patent Application Publication
(10) Pub. No.: US 2005/0046127 A1
(43) Pub. Date: Mar. 3, 2005

(54) WHEEL MOVEMENT BLOCKING MECHANISM OF A GOLF CART

(76) Inventors: Pao-Hsien Cheng, Tainan Hsien (TW); Ying-Hsiung Cheng, Tainan Hsien (TW); Michel Don Wade, San Diego, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/647,348

(22) Filed: Aug. 26, 2003

(51) Int. Cl. B60T 1/00

(52) U.S. Cl. 280/19; 188/31

(57) ABSTRACT

A movement blocking mechanism of a golf cart includes a holding base secured to a support of a wheel, a spring biased upper shell up and down movably positioned over the base, a spring biased sliding block movably received in the base, an engaging rod projecting from a front end of the sliding block, and a disk connected to the wheel; the shell and the sliding block have opposing sloping portions so that the block will be moved forwards when the upper shell is depressed, and in turns, the engaging rod projects from the front of the base to engage the disk to block movement of the wheel; the sliding block will be detained in front portion of the base after moving forwards on depression and release of the shell, and can be released from the detention when the shell is depressed again.

### BACKGROUND OF THE INVENTION

1. Field of the Invention

The present invention relates to a wheel movement blocking mechanism of a golf cart, more particularly one, which is convenient to use, and which can function no matter in what kind of shape the ground surface is where the golf cart is supported.

2. Brief Description of the Prior Art

Referring to FIG. 10, a golf cart 13 is equipped with a conventional movement blocking member, which consists of a connecting portion 10, an extension portion 11 projecting from the connecting portion 10, an upwards folded portion 12 connected to the extension portion 11, and a slip-prevention element 15 secured to a lower side of the upwards folded portion 12. The connecting portion 10 is firmly joined to a base 14 of the golf cart 13 such that the extension portion 11 and the upwards folded portion 12 are directed to back of the golf cart 13, as shown in FIG. 11. When the golf cart is being pushed along, the user has to press down a handle 16 of the cart such that the slip-prevention element 15 contacts a ground surface, and the golf cart is slowed down and stopped. After the golf cart is stopped, it will be moved back to the upright in-use position, and supported on the ground by means of the rear wheels and the front wheels instead of the movement blocking member.

The golf cart is found to have disadvantages as followings:
1. It will take much strength to press down the handle 16 to stop the golf cart, especially when the cart is loaded with many golf clubs, which are relatively heavy in weight. Therefore, the golf cart is not convenient to use.
2. The golf cart has to be supported on a ground surface in the upright in-use position by means of the rear wheels and the front wheels. Consequently, the golf cart won't keep still in case the ground surface where it is supported is not level.

### SUMMARY OF THE INVENTION

It is a main object of the present invention to provide a movement blocking mechanism of a golf cart to overcome the above disadvantages.

The movement blocking mechanism of the present invention includes a holding base, an upper shell, a sliding block, an engaging rod, and engaging disk. The holding base is secured to a support of a wheel. The upper shell up and down movably positioned over the base, and is biased upwards by a first spring. The sliding block is forwards and rearwards movably received in the base, and is biased rearwards of the base by a second spring. The engaging rod projects from a front end of the sliding block to oppose a hole of the front end of the base. The engaging disk is connected to the wheel. The shell and the sliding block have opposing sloping portions so that the block will be pushed forwards by the shell when the upper shell is depressed, and in turns, the engaging rod projects from the front hole of the base to engage the disk to block movement of the wheel. The sliding block will be detained in the front portion of the base after moving forwards on depression and release of the shell, and will be released from the detention for the engaging rod to disengage the disk when the shell is depressed again.

### BRIEF DESCRIPTION OF THE DRAWINGS

The present invention will be better understood by referring to the accompanying drawings, wherein:

FIG. 1 is an exploded perspective view of the wheel movement blocking mechanism of a golf cart according to the present invention,

FIG. 2 is a partial exploded perspective view of the golf cart according to the present invention,

FIG. 3 is a front view of inside of the wheel movement blocking mechanism according to the present invention,

FIG. 4 is a top view of the wheel movement blocking mechanism according to the present invention,

FIG. 5 is a side view of the wheel movement blocking mechanism according to the present invention,

FIG. 6 is a front view of inside of the present wheel movement blocking mechanism, with the upper shell being depressed,

FIG. 7 is a side view of the present wheel movement blocking mechanism, with the upper shell being depressed,

FIG. 8 is a front view of the present wheel movement blocking mechanism, in the blocking position,

FIG. 9 is a top view of the movement blocking mechanism, in the blocking position,

FIG. 10 is a side view of the conventional movement blocking member as described in the Background, and

FIG. 11 is a side view of a golf cart with the conventional movement blocking member.

### DETAILED DESCRIPTION OF THE PREFERRED EMBODIMENTS

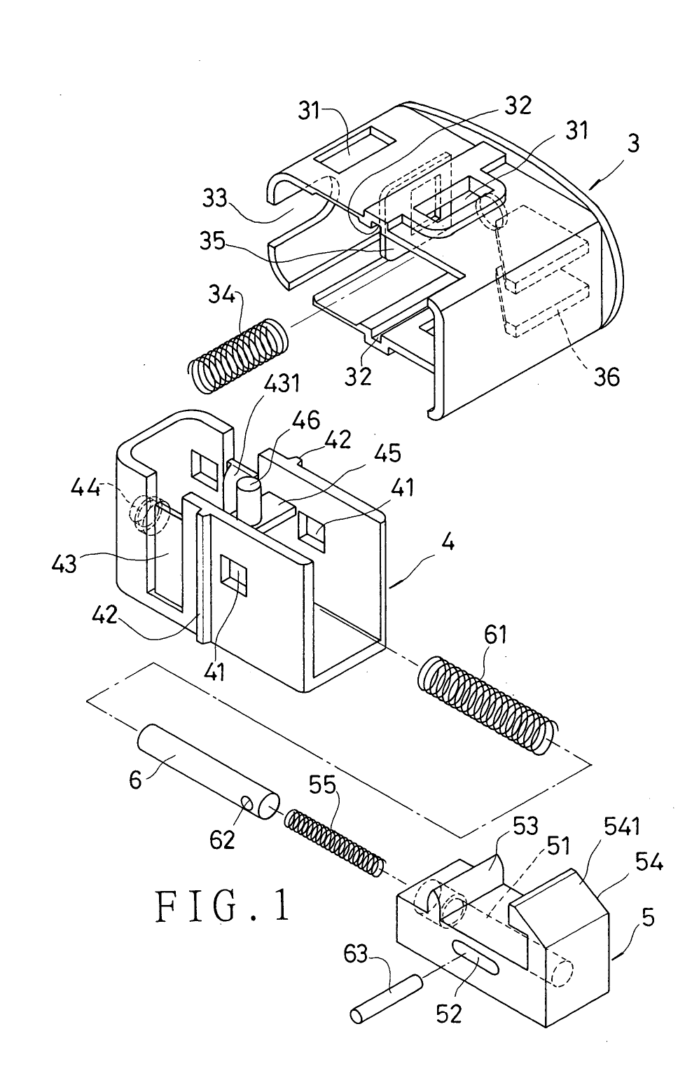

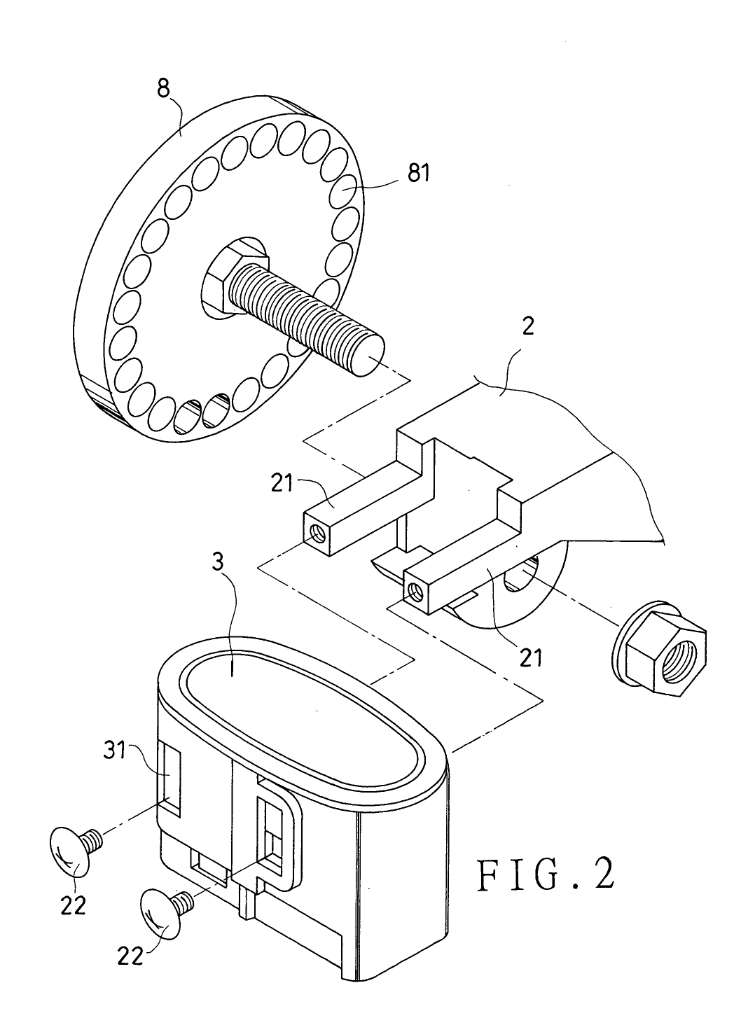

Referring to FIGS. 1, and 2, a preferred embodiment of a movement blocking mechanism of a golf cart in the present invention includes an upper shell 3, a holding base 4, a sliding block 5, an engaging rod 6, and an engaging disk 8.

The upper shell 3 has two pairs of opposing elongated through holes 31 on lateral portions, straight guiding trenches 32 on inner sides of the lateral portions, a gap 33 on a front end, an actuating plate 35 projecting down from an upper portion therein, and two juxtaposed pushing plates 36, which project down from the upper portion, and are formed with sloping lower edges.

The holding base 4 has a holding space (not numbered) therein, two pairs of opposing through holes 41 on lateral portions, straight guiding bars 42 on outer sides of the lateral portions, two opposing flexible engaging plates 43 at respective ones of lateral sides and near to a front end thereof, a through holes on the front end, a transverse board 45 connected to upper end portions of both lateral portions, and a locating post 46 on the transverse board 45. Each of the flexible engaging plates 43 is formed with a hook portion 431 on an inward side of an upper end thereof. The flexible engaging plates 43 normally stand upright with the hook portions 431 projecting beyond the inner sides of the lateral portions of the holding base 4.

The sliding block 5 has a holding hole 51, which extends from a front end to a rear portion near to a rear end of the block 5, and which consists of a rear section, and a front section bigger than the rear section in diameter; a shoulder is formed in the holding hole 51 between the front and the rear sections. The sliding block 5 is formed with a slot 52, which extends from one lateral side of the block 5 to the other, and communicates with the rear section of the holding hole 51. In addition, the sliding block 5 is formed with a first projection 53 on an upper side of a front portion, and a second projection 54 on an upper side of a rear portion thereof; the second projection 54 has a sloping side 541 thereon.

The engaging rod 6 has a transverse hole 62 near to a rear end thereof. And, the engaging disk 8 is formed with spaced engaging cavities 81 near to the edge of one side thereof.

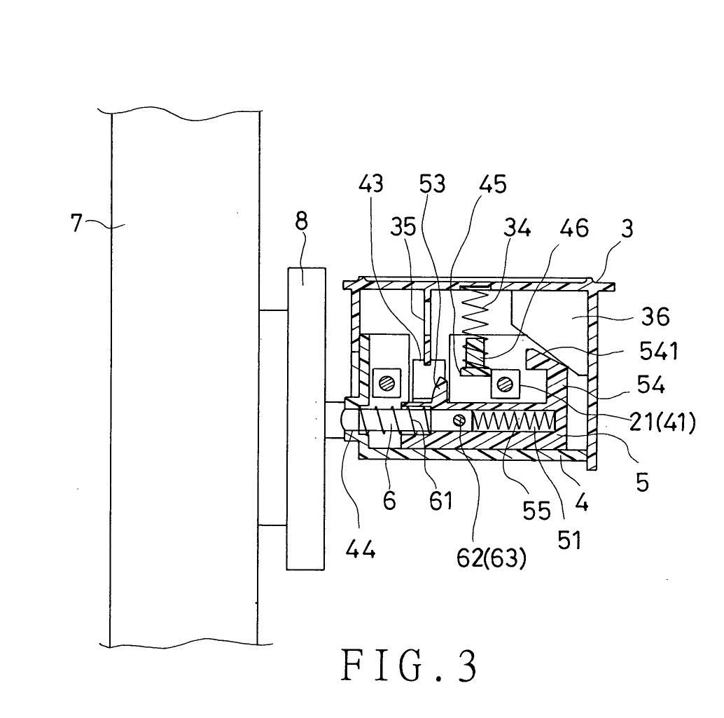

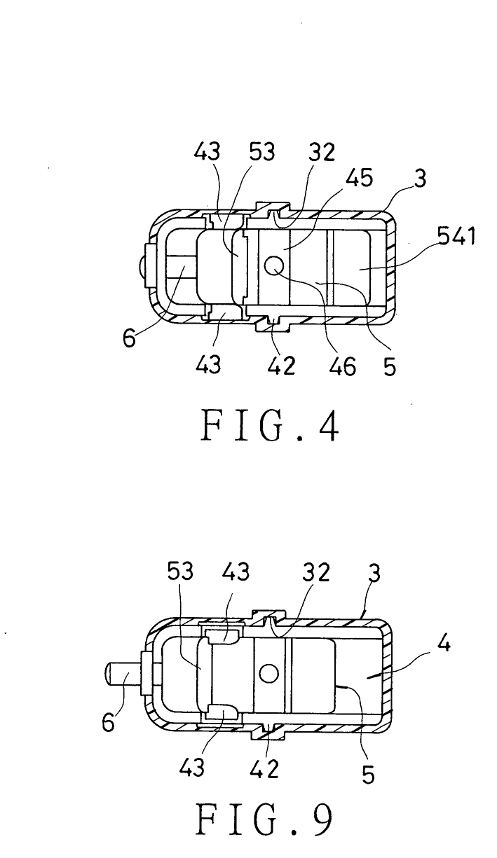

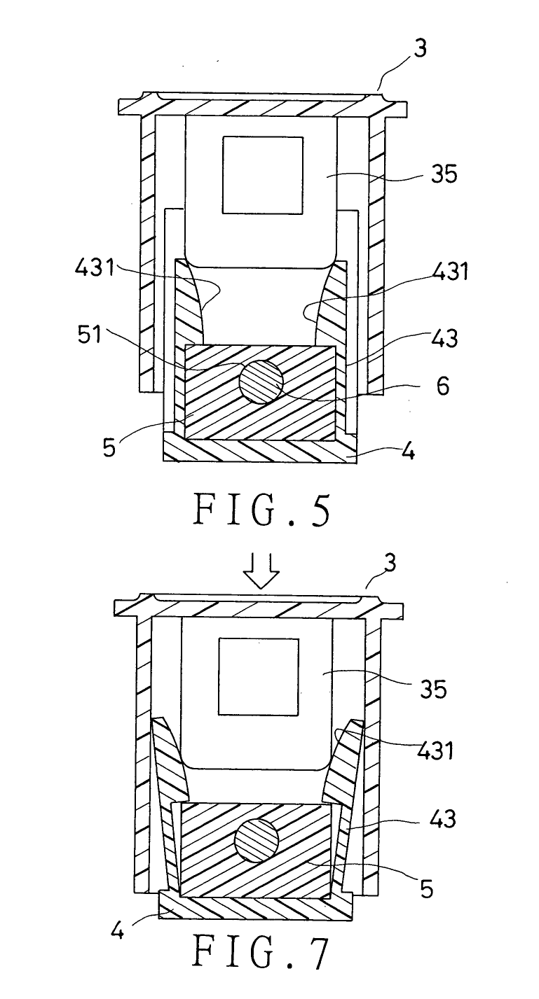

Referring to FIG. 2, the present movement blocking mechanism is joined to a wheel support 2 of a golf cart, which is formed with two elongated connecting projections 21 each having an axial screw hole. Referring to FIGS. 2 to 5 for the present movement blocking mechanism, assembled and fitted to the golf cart, the engaging disk 8 is connected to a wheel 7, which is supported on the wheel support 2, so as to be rotary together with the wheel. The sliding block 5 is forwards and backwards movably received in the holding base 4 while the engaging rod 6 is passed into the holding hole 51, and directed into the front through hole 44 of the base 4; an elastic element 55, which is smaller than the engaging rod 6 in diameter, is disposed in the rear section of the holding hole 51 to make the engaging rod 6 project further from the front end of the sliding block 5; a pin 63 is passed through the slot 52, and fitted into the transverse hole 62 of the engaging rod 6; an elastic element 61 abuts the front end of the base at one end, and abuts the shoulder of the holding hole 51 at the other end after having been passed around the engaging rod 6 such that the sliding block 5 is normally biased towards the rear end of the holding base 4. The upper shell 3 is up and down movably connected to an upper end of the holding base 4 with the guiding trenches 32 being over upper ends of respective guiding bars 42, and with the elongated holes 31 facing respective through holes 41; the actuating plate 35 is right above the hook portions 431 of the engaging plates 43; the sloping lower edges of the pushing plates 36 are right above the sloping side 541 of the second projection 54 such that the pushing plates 36 will be pressed against the sloping side 541 to cause forward movement of the sliding block 5 when the upper shell 3 is moved downwards; an elastic element 34 is fitted around the locating post 46 of the holding base 4 at lower end, and connected to the upper portion of the shell 3 at upper end to bias the upper shell 3 upwards relative to the base 4.

The upper shell 3 and the holding base 4 are connected to the wheel support 2 with the elongated connecting projections 21 being passed through the shell 3 and the base 4 via the elongated through holes 31 and the through holes 41, and with the front hole 44 of the base 4 being directed to the engaging cavities 81 of the engaging disk 8; thus, the holding base 4 is kept still while the upper shell 3 is biased upwards by the elastic element 34, and can be pressed down until upper ends of the elongated through holes 31 abut the connecting projections 21; threaded fixing elements 22 are connected to the screw holes of the elongated connecting projections 21 to prevent the shell 3 and the base 4 from separating from the wheel support 2.

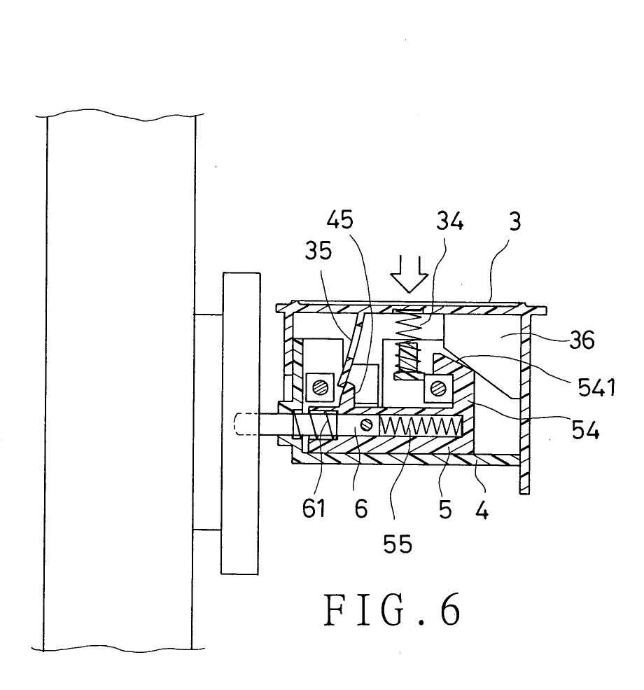

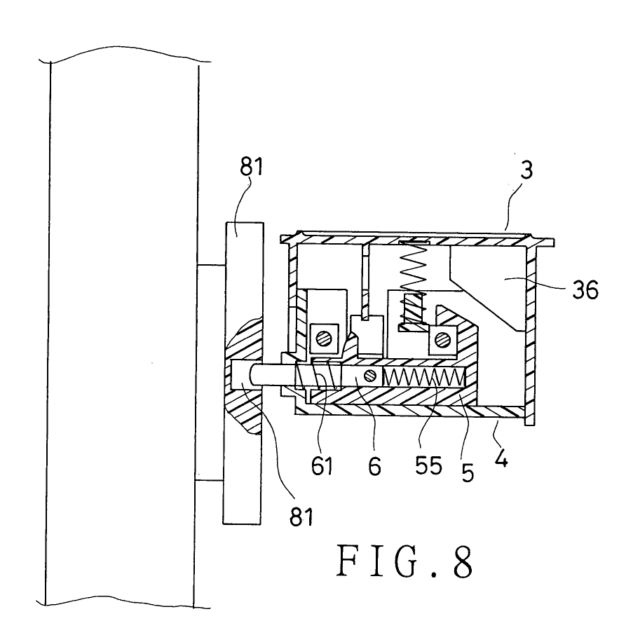

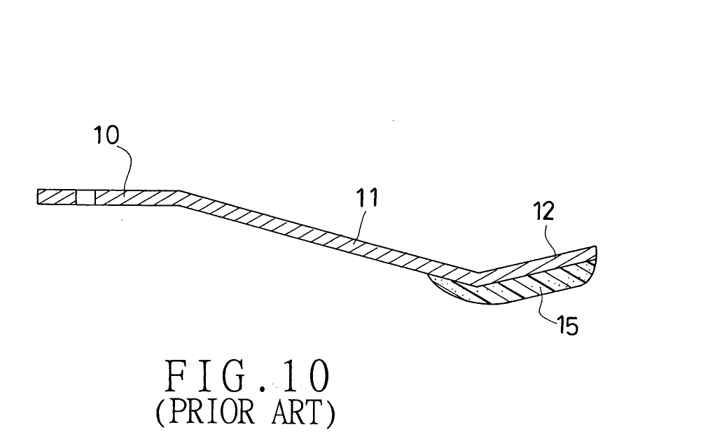

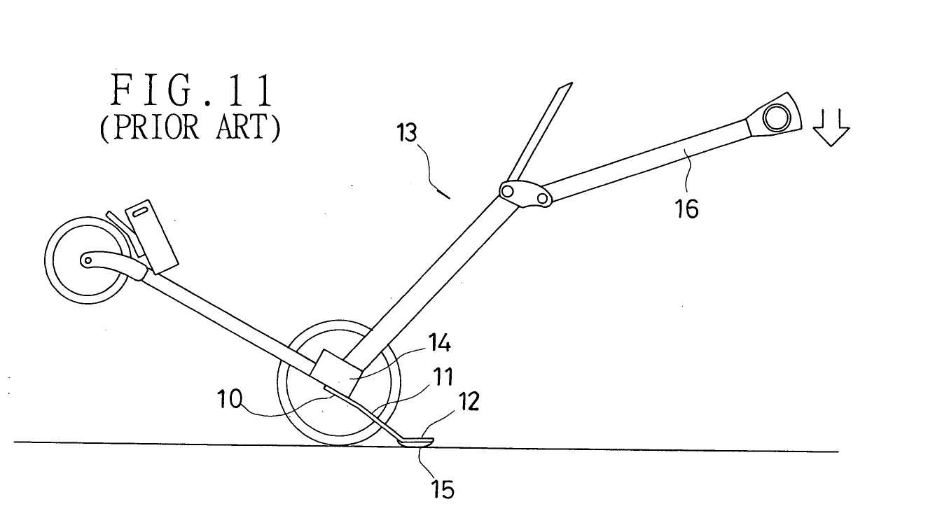

Referring to FIGS. 6 to 9, to use the present mechanism to block movement of the golf cart, the upper shell 3 is depressed, and then released such that the sliding block 5 is forced to move forwards by the pushing plates 36, and the first projection 53 forces the flexible engaging plates 43 to bend outwardly of the holding base 4, and passes beyond the hook portions 431 of the plates 43. Consequently, the engaging rod 6 projects from the front hole 44 of the holding base 4, and passes into one of the engaging cavities 81 of the disk 8 to prevent the wheel 7 from turning. The flexible engaging plates 43 will move back to its original position immediately after the first projection 53 passes beyond the hook portions 431, and in turns, the hook portions 431 block rearward movement of the sliding block 5.

To release the wheel 7 and the disk 8, the upper shell 3 is depressed such that the actuating plate 35 is pressed against the flexible engaging plates 43 to force the plates 43 to bend outwardly of the holding base 4, and the hook portions 431 are disengaged from the first projection 53. Consequently, the elastic element 61 forces the sliding block 5 to move rearwards, and the engaging rod 6 retreats accordingly, and disengages the engaging cavity 81. Thus, the wheel 7 is allowed to turn.

In case none of the cavities 81 of the engaging disk 8 opposes the engaging rod 6 when the upper shell 3 is depressed to make the engaging rod 6 project further from the front hole 44, the sliding block 5 will still be locked in the front portion of the base 4 by the hook portions 431 with the engaging rod 6 being pressed against between two adjacent ones of the cavities 81, and with the elastic element 55 being compressed. Thus, the engaging rod 6 will pass into one of the engaging cavities 81 of the disk 8 automatically as soon as the user makes the wheel 7 turn for a very small angle, and movement of the wheel 7 is blocked accordingly.

From the above description, it can be easily understood that the present movement blocking mechanism of a golf cart has advantages as followings:
1. The user only has to press down the upper shell 3 to block movement of the golf cart therefore the present movement blocking mechanism is convenient to use.
2. Because the engaging rod 6 will, after depression and release of the upper shell 3, stay engaged with the disk 8 unless the upper shell 3 is pressed down and released again, the golf cart will keep still even if the ground surface where it is supported is not level.
3. When the upper shell 3 is depressed to make the present mechanism function, the sliding block 5 will still be locked with the hook portions 431 in case none of the cavities 81 of the engaging disk 8 opposes the engaging rod 6, and the engaging rod 6 will pass into one of the engaging cavities 81 automatically due to the elastic element 55 immediately after the user makes the wheel 7 turn for a very small angle.

1. A movement blocking mechanism of a golf cart, comprising:
an upper shell, the upper shell having a plurality of pairs of opposing elongated through holes on lateral portions; the upper shell having a plurality of straight guiding trenches vertically extending along inner sides of the lateral portions; the upper shell having a first elastic element projecting down from an upper portion; the upper shell having an actuating plate projecting down from the upper portion in front of the first elastic element; the upper shell having two juxtaposed pushing plates projecting down from the upper portion behind the first elastic element; the pushing plates being each formed with a sloping lower edge;
a holding base, the upper shell being positioned over a top of the holding base with the elongated through holes opposing respective ones of lateral through holes of the base, and with the straight guiding trenches being fitted over respective ones of straight guiding bars of the base; the first elastic element being passed around a locating post projecting from an upper portion of the base to bias the upper shell upwards relative to the base; the holding base having two opposing flexible engaging plates on lateral portions and near to a front end thereof; each flexible engaging plate having a hook portion on an inward side of an upper end thereof; the holding base having a through hole on a front portion; the hook portions normally projecting beyond inner sides of the lateral portions of the holding base;
the holding base with the upper shell being passed around elongated projections of a support of a wheel of the golf cart at the lateral through holes of the base as well as the elongated through holes of the upper shell such that the base is kept still on the wheel support, and such that the upper shell is up and down movable relative to the base; threaded fixing elements being connected to the elongated projections of the wheel support to prevent the base and the upper shell from falling off;
a sliding block forwards and rearwards moveably received in the holding base; the sliding block having a holding hole extending from a front end to a rear portion near to a rear end thereof; the sliding block having first and second projections on front and rear portions of an upper side thereof respectively; the second projection having a sloping side opposing the sloping lower edges of the pushing plates of the upper shell such that downward movement of the upper shell will cause forward movement of the sliding block; the sliding block being biased rearwards of the holding base by a second elastic element; the sliding block having a third elastic element received in a rear section of the holding hole;
an engaging rod held in the holding hole and projecting from the sliding block; the engaging rod being biased forwardly of the block by means of the third elastic element;
an engaging disk connected to, and rotary together with the wheel; the engaging disk being formed with spaced engaging cavities near to an edge thereof;
the engaging rod projecting through the front through hole of the base and into one of the engaging cavities to block rotation of the wheel when the upper shell is depressed and released to make the sliding block move to a front section of the holding base; the hook portions of the flexible engaging plates engaging the first projection of the sliding block to detain the block in the front section of the base when the upper shell is depressed and released to make the sliding block move to the front section of the holding base; the actuating plate making the flexible engaging plates bend outwardly of the base when the upper shell is pressed down, thus making the hook portions disengage the first projection of the sliding block for the block to be biased to a rear section of the base by the second elastic element.

2. The movement blocking mechanism of a golf cart as claimed in claim 1, wherein the sliding block is formed with a slot extending from one lateral side to other lateral side to communicate with the holding hole while the engaging rod has a transverse hole near to a rear end thereof, and is connected to a pin, which is passed through the transverse hole and the slot.
